(19) United States
(12) Patent Application Publication
(10) Pub. No.: US 2013/0334305 A1
(43) Pub. Date: Dec. 19, 2013

(54) SYSTEM AND METHOD FOR GENERATING A MEDICAL EXAMINER'S CERTIFICATE

(71) Applicants: Tony M. Baker, Elizabeth, CO (US); David A. Gallant, Denver, CO (US)

(72) Inventors: Tony M. Baker, Elizabeth, CO (US); David A. Gallant, Denver, CO (US)

(21) Appl. No.: 13/571,082

(22) Filed: Aug. 9, 2012

Related U.S. Application Data
(60) Provisional application No. 61/659,226, filed on Jun. 13, 2012.

(51) Int. Cl. G06F 17/40

(52) U.S. Cl. 235/380

(57) ABSTRACT

A system and method for generating a medical examiner's certificate for a commercial driver is disclosed. According to the system and method, a form may be generated by a network device and transmitted to a personal computer. The form contains at least one automatic input field that is populated with information scanned from the commercial driver's drivers license. The form also contains at least one manual field that is populated via manual input by a user of the system.

### CROSS-REFERENCE TO RELATED APPLICATIONS

This application claims the benefit of U.S. Provisional Application No. 61/659,226, filed Jun. 13, 2012, for SYSTEM AND METHOD FOR GENERATING A MEDICAL EXAMINER'S CERTIFICATE of Tony M. Baker and David A. Gallant, which is hereby incorporated by reference for all that is disclosed therein.

### BACKGROUND

It is widely recognized that driving certain commercial motor vehicles (CMVs) requires special skills and knowledge. In the United States, federal laws and regulations have dictated that drivers (or “operators”) have a commercial driver's license (CDL) in order to drive certain CMVs since Apr. 1, 1992. CDL's are issued by each state, usually through the state's Department of Motor Vehicles.

The federal Commercial Motor Vehicle Safety Act of 1986 was signed into law on Oct. 27, 1986. The stated goal of the Act is to improve highway safety by ensuring that operators of large trucks and buses are qualified to operate those vehicles and to remove unsafe and unqualified operators from the highways. The Act retained the State's right to issue a driver's license, but established minimum national standards which States must meet when issuing CDLs. When an individual applies for a CDL, or attempts to renew or update a CDL, for example, the State must perform a check of its own database, the Commercial Driver's License Information System (CDLIS), and the National Driver Register (NDR), to ensure that the operator is not disqualified and does not possess a license from more than one jurisdiction.

Federal law and regulation also requires that all CDL holders have a U.S. Department of Transportation (DOT) medical examiner's certificate attesting to the operator's fitness to drive. Medical examiner's certificates are issued by various doctors offices and carried by the operators. Accordingly, a CDL operator generally must have a current (unexpired) state-issued CDL and a current DOT medical examiner's certificate in order to legally operate a commercial motor vehicle.

Recent changes to Federal law and regulation (effective Jan. 30, 2012) now require, for example, that each licensing state must retain an original or a copy of the medical examiner's certificate for each operator it licenses and post certain information from the medical examiner's certificate to the CDLIS driver record and update certain changes in status within ten days.

There is currently no efficient way to track medical examiner's certificates or to correlate data from a medical examiner's certificate to the corresponding state-issued CDL. Thus, it would be desirable to have a system that would correlate an operator's CDL and medical card.

### BRIEF DESCRIPTION OF THE DRAWINGS

FIG. 1 is a flowchart depicting a portion of an exemplary system for generating a medical examiner's certificate.

FIG. 2 is a rear perspective view of an exemplary network device useable in conjunction with the system of FIG. 1.

FIG. 3 is an exemplary initial screen shot showing an exemplary form generated by the system of FIG. 1.

FIG. 4 is a further exemplary screen shot showing an exemplary form generated by the system of FIG. 1.

FIG. 5 is a further exemplary screen shot showing an exemplary form generated by the system of FIG. 1.

FIG. 6 is a further exemplary screen shot showing an exemplary form generated by the system of FIG. 1.

FIG. 7 is a further exemplary screen shot showing an exemplary form generated by the system of FIG. 1.

FIG. 8 is a flowchart depicting another portion of the exemplary system for generating a medical examiner's certificate of FIG. 1.

### DETAILED DESCRIPTION

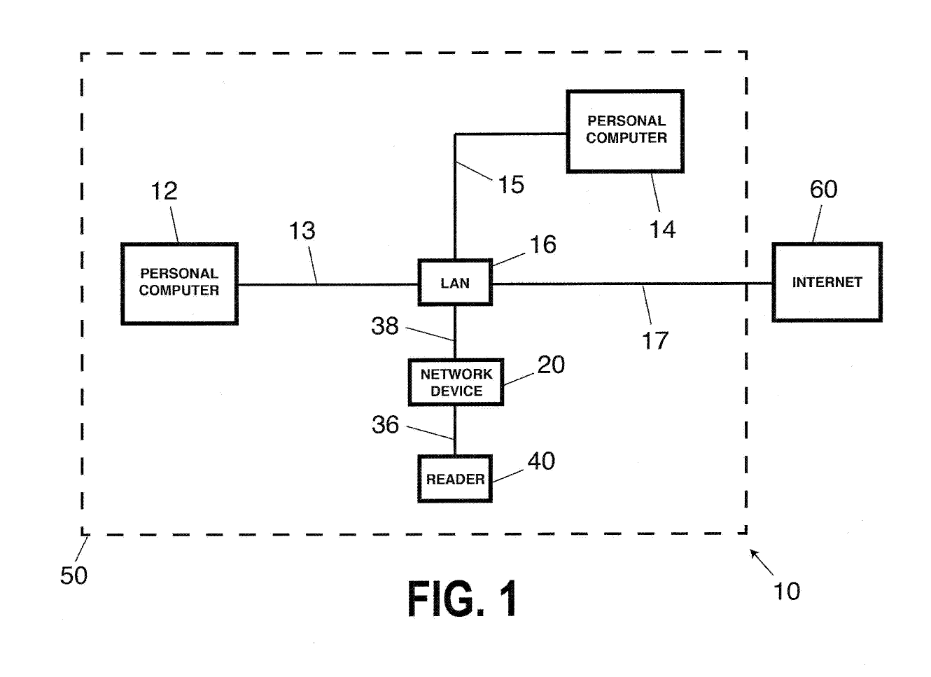

FIG. 1, in general terms, schematically illustrates a portion of a system 10 that may be used to generate a U.S. Department of Transportation (DOT) medical examiner's certificate. More specifically, the system 10 is capable of capturing information from a state-issued driver's license and merging it with an electronic medical examiner's certificate form on a personal computer. A human user (sometimes referred to herein simply as a “user”) located, e.g., in a medical examiner's office, may then input information to the electronic form pertaining to the medical examination of the operator that has been recently completed. Once this information is entered, the medical examiner's certificate (including data merged from the driver's license and information entered by the user) is completed and then may be printed, if desired. An electronic version of the completed medical examiner's certificate may then be saved and/or uploaded to a remote location (e.g., a server connected to the internet) for later retrieval by the appropriate state licensing authority.

With continued reference to FIG. 1, the system 10 would typically be located within a facility 50 where DOT medical exams are administered, e.g., a doctor's office. The system 10 may include personal computers 12 and 14 which may be interconnected via a local area network 16. Specifically, the personal computers 12 and 14 may be connected to the local area network 16 via the connections 13 and 15, respectively, as shown in FIG. 1. Connections 13 and 15 may, for example, be ethernet connections or may take the form of wireless connections in a conventional manner. Local area network 16 may be any device that facilitates exchange of information and may, for example take the form of a router or server, in a conventional manner. Local area network 16 may be connected to the internet 60 via a connection 17 in a conventional manner.

With continued reference to FIG. 1, a network device 20 may be attached to the local area network 16, as shown. The network device 20, in general terms, may be a self contained device that automates and secures the acquisition and transmission of DOT medical card records to DMV offices. A license reader 40 may be connected to the network device 20, as shown. License reader 40 may be any device capable of capturing data from a state-issued driver's license and may take the form, for example, of a magnetic strip reader (similar to that used for credit cards) or a barcode reader (e.g., a barcode scanner adapted to read an industry standard PDF417 barcode).

It is noted that the system 10 may take various alternative forms and that the particular configuration illustrated in FIG. 1 is shown for exemplary purposes only. In one alternative form, for example, a personal computer (e.g., the personal computer 12 or 14) may be connected directly to the internet 60 without the use of the local area network 16. In this case, the network device 20 may be directly connected to the personal computer. Other variations will be readily apparent to persons skilled in the relevant arts.

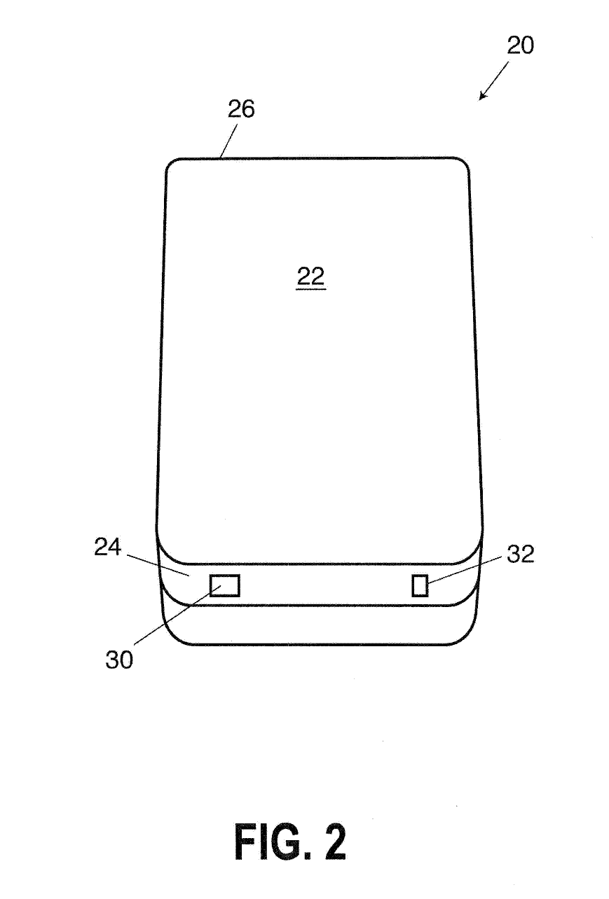

FIG. 2 illustrates the network device 20 in further detail. As can be seen from FIG. 2, the network device 20 may include a housing 22 having a front panel 24 and an oppositely disposed back panel 26. Various connections may be provided on the front panel 24 as will now be described in further detail. The front panel 24 may, for example, include an ethernet port 30 which may be provided to facilitate the connection 38 (FIG. 1) between the network device 20 and the local area network 16. The front panel 24 may also include a USB port 32, as shown. The USB port 32 may be used, for example, to connect data acquisition equipment (e.g., the license reader 40, a barcode scanner, a signature tablet, etc.). A power port (not shown) may be located, for example, on the back panel 26 in order to supply operating power to the network device 20 in a conventional manner.

The network device 20 may be configured to provide a web-based software interface. To provide this interface, the network device 20 may be loaded, in a conventional manner, with web application software, e.g., a software application that is coded in a browser-supported language (such as JavaScript, combined with a browser-rendered markup language like HTML which are supported by a variety of web browser applications). Accordingly, the network device 20 is capable of serving web pages to devices (e.g., the personal computers 12, 14, FIG. 1) connected to the network device 20 via the local area network 16. The network device 20 offers a high level of cross-platform compatibility; virtually any network-enabled personal computer running a standard web browser, for example, can access web pages served by the network device 20. The network device 20 also provides for secure network communication. The web browser interface generated by the network device 20 may, for example, use a protocol such as HTTPS (SSL/TLS) for encoding data transmitted over the network.

Having described various physical attributes of the system 10, an exemplary method of using the system to generate a medical examiner's certificate for an operator will now be described. It is to be understood that the process described below typically would begin after the operator has been examined by a doctor or other medical professional working at the facility 50.

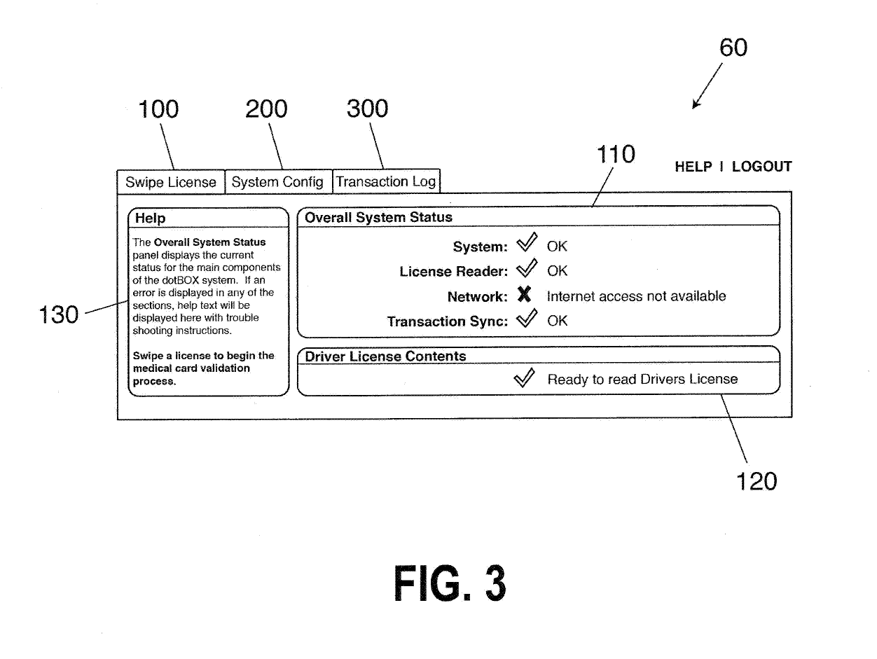

To begin the process, a user (e.g., a doctor or other medical professional working at the facility 50, FIG. 1) may open any conventional browser application on one of the personal computers connected to the local area network 16 within the system 10, e.g., the personal computer 12, FIG. 1. Next, the user may point the web browser at the network device 20 (i.e., by entering the internet protocol address of the network device into the browser's address window). This, in turn, causes the network device 20 to generate an initial web page on the personal computer 12. FIG. 3 schematically illustrates an exemplary screen shot of the displayed initial web page 60.

With reference to FIG. 3, the initial web page 60 may include a series of tabs 100, 200 and 300 which may, for example, be entitled “Swipe License”, “System Config” and “Transaction Log”, respectively. Each of the tabs may be selected by the user using a conventional computer pointing device, e.g., a mouse.

The System Config tab 200 allows for the configuration of the local network device 20 by the user. Thus, the user might use the System Config tab 200, for example, to specify a specific network address (static IP address) for the network device 20 or to add or change a password to access the system.

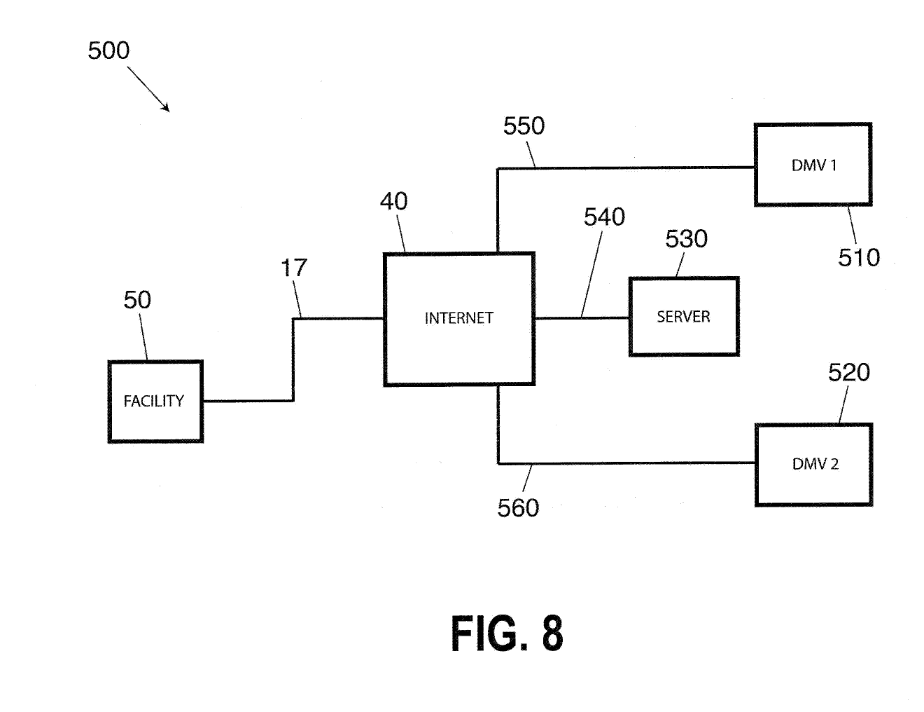

The Transaction Log tab 300 may be selected to show transactions that have occurred between the network device 20 and a server connected to the internet (e.g., the server 530, FIG. 8). The transactions may be listed in a simple log format such that no sensitive data is either displayed or retained.

To continue with the medical examiner's certificate generation process, the user may select the “Swipe License” tab 100, as shown in FIG. 3. The “Swipe License” tab 100 may, for example, include a series of panels where information is displayed. An “Overall System Status” panel 110, for example, may provide information to the user regarding the status of the overall system, the status of the license reader 40, the status of the network connection and a transaction sync status. The transaction sync status indicates whether or not all pending transfers from the network device 20 to the server (e.g., the server 530, FIG. 8) have been completed. If the network device is disconnected from the local area network 16 or the internet connection is not available, a mode of operation is available where data is saved until the communication is reestablished. When the “sync status” reads “good” or “ok”, this means that there are no outstanding requests. A “sync status” of “pending” means there are outstanding requests that have not yet been sent. In an alternative mode of operation, the system may not allow a drivers license to be swiped until and unless the network device 20 can communicate with the outside internet.

With continued reference to FIG. 3, a “Driver License Contents” panel 120 may include an indication that the system is ready for the user to swipe a driver's license (using the license reader 40). A “Help” panel 130 may include general information regarding the tab being displayed (i.e., the tab 100 in the view of FIG. 3) and can provide additional information in the case where an error status exists with respect to one of the items in the “Overall System Status” panel 110.

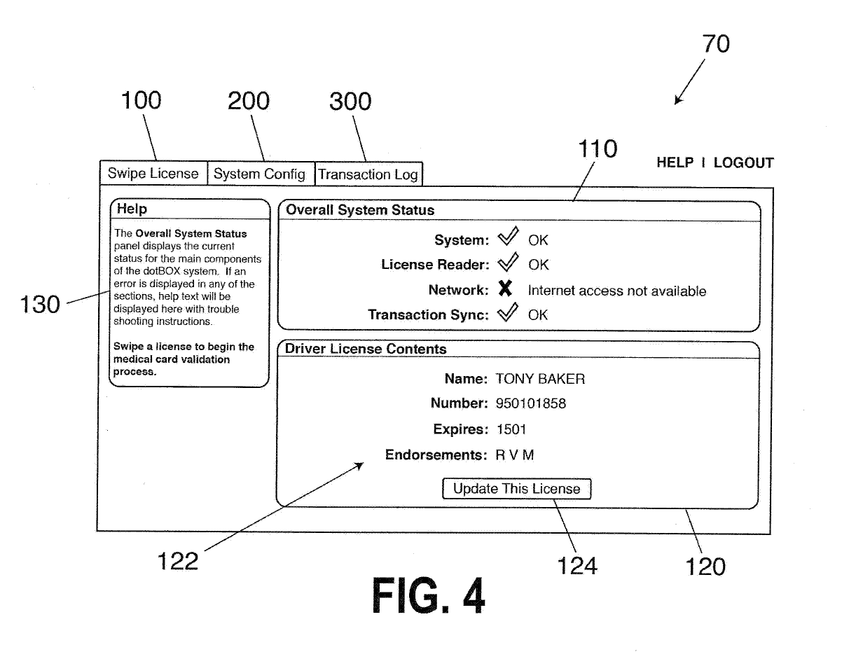

To continue the process, the user may next swipe the operator's driver's license, using the license reader 40, FIG. 1. As noted previously, the license reader 40 may take the form, for example, of a magnetic strip reader or a barcode scanner. Alternatively, both types of readers may be connected to the system when different types of driver's licenses need to be scanned. When the operator's driver's license has been swiped by the license reader 40, the network device 20 will generate new web page on the personal computer 12. FIG. 4 schematically illustrates an exemplary screen shot of this new web page 70.

With reference to FIG. 4, the new web page 70 may again include the series of tabs 100, 200 and 300 described above with respect to the initial web page 60 described above with respect to FIG. 3. Again, the “Swipe License” tab 100 is selected in the view of FIG. 4. As can be seen from FIG. 4, the “License Contents” panel 120 now displays information 122 read from the operator's driver's license. Specifically, the panel 120 may display information such as the driver's name, the license number and expiration date corresponding to the license, and any endorsements that may apply. In this manner, the user may confirm that the correct driver's license has been scanned. The panel 120 now also may include a “button” 124 labeled, for example, “Update This License”. After reviewing the information scanned from the driver's license, as discussed above, the user may activate the button 124 to continue with the medical examiner's certificate generation process. The button 124 may be activated by the user by using a conventional computer pointing device, e.g., a mouse, to click on the button.

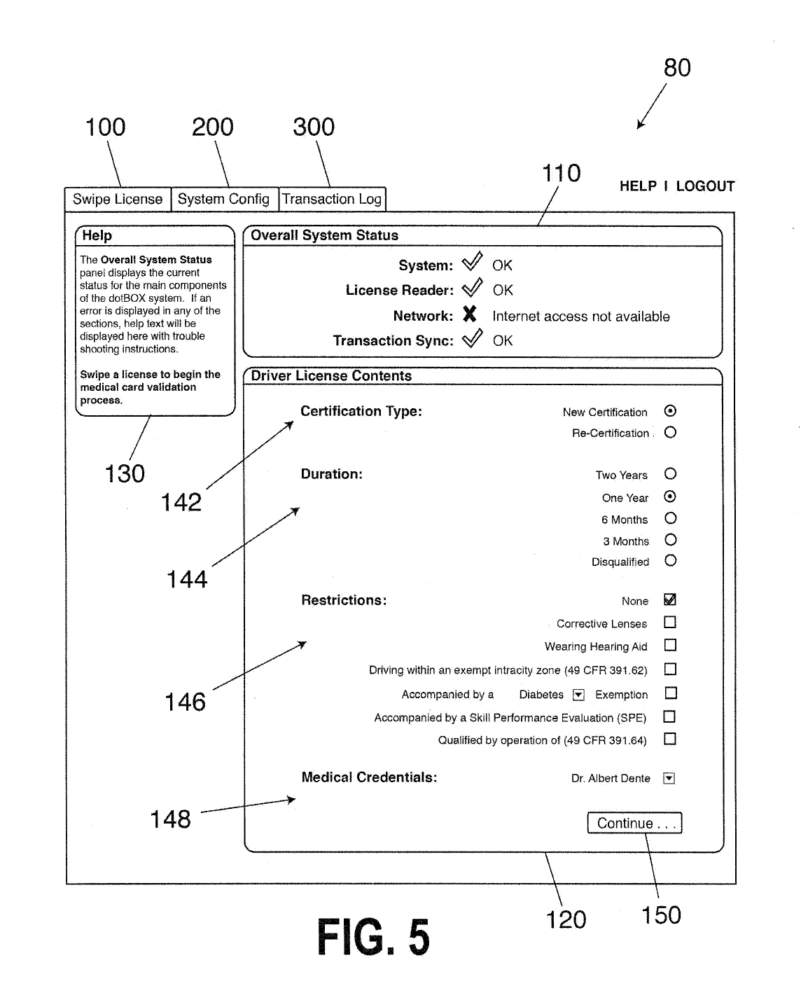

When the user activates the button 124 in FIG. 4, the network device 20 will generate a new web page on the personal computer 12. FIG. 5 schematically illustrates an exemplary screen shot of this new web page 80. With reference to FIG. 5, the new web page 80 may again include the series of tabs 100, 200 and 300 described in conjunction with the initial web page 60 discussed above with respect to FIG. 3. Again, the “Swipe License” tab 100 is selected in the view of FIG. 5. As can be seen from FIG. 5, the “Driver License Contents” panel may now include a series of input areas where the user can select from a number of input options, as described in further detail below.

A first input area 142 may, for example, be entitled “Certification Type”. As can be seen with reference to FIG. 5, in the first input area 142, the user may choose one of two choices; i.e., either “New Certification” or “Re-certification”. In this manner, the user can select, in the first input area 142 whether the current certification is a new certification or a re-certification.

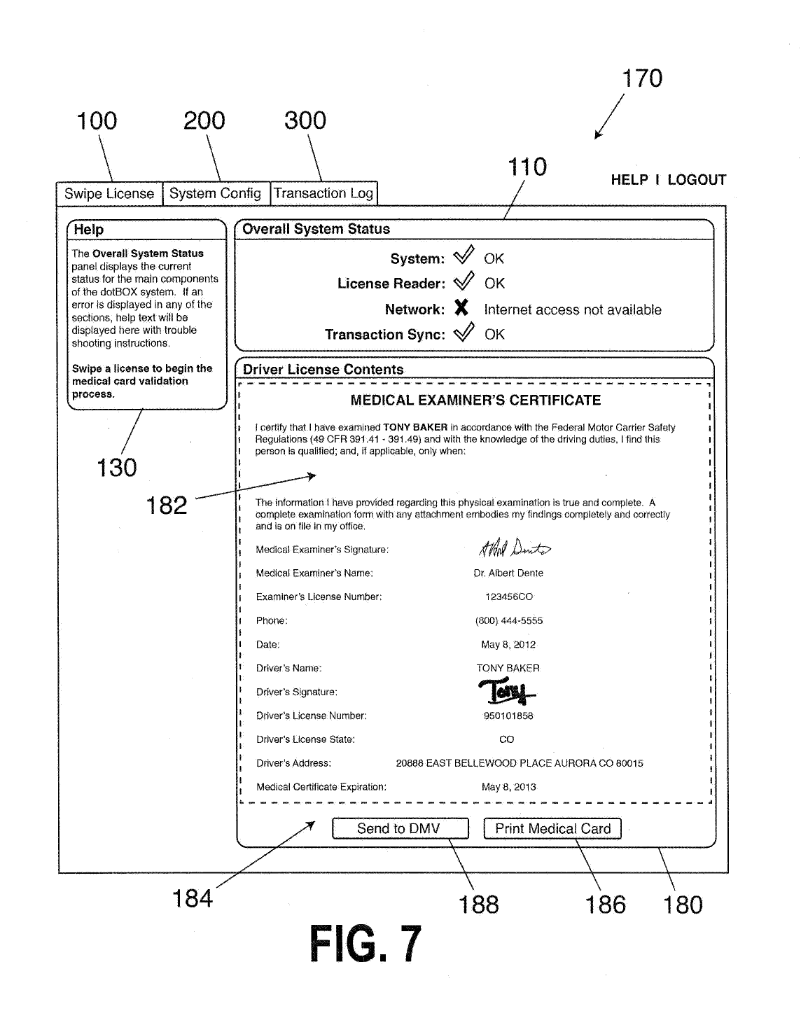

With continued reference to FIG. 5, a second input area 144 may, for example, be entitled “Duration”. In the second input area 144, the user can select from a number of duration periods for the medical examiner's certificate being generated. A third input area 146 may, for example, be entitled “Restrictions”. In the third input area 146, the user may indicate any restrictions that may apply to the medical examiner's certificate, based on the previously-completed examination of the operator. Any restrictions selected in the third input area 146 will populate into the PDF image 182, FIG. 7, as will be further described herein.

It is noted that the various choices presented in the input areas 142, 144 and 146, as described above, may, for example, be presented in a “radio button” format, as illustrated in FIG. 5. In this manner, the user may execute various choices simply by using a conventional computer pointing device, e.g., a mouse.

With further reference to FIG. 5, a fourth input area 148 may, for example, be provided in order to identify the doctor or other medical professional who has administered the examination to the operator. Specifically, the fourth input area 148 may be in the form of a conventional drop-down list that includes the name and signature of each doctor or other medical professional working at the facility 50. These names and signatures may be pre-programmed into the system so that the user only need select from an existing list of names. Again, the selection in input area 148 may be made simply by using a mouse or other conventional computer pointing device. The name and signature selected in the fourth input area 148 will automatically populate into the completed medical examiner's certificate shown in FIG. 7.

With continued reference to FIG. 5, a fifth input area 150 may include a “Continue” button. After the user has completed making all desired selections in the input areas 142, 144, 146 and 148, as described above, the user may click on the Continue button in the input area 150 (again using a mouse or other conventional computer pointing device).

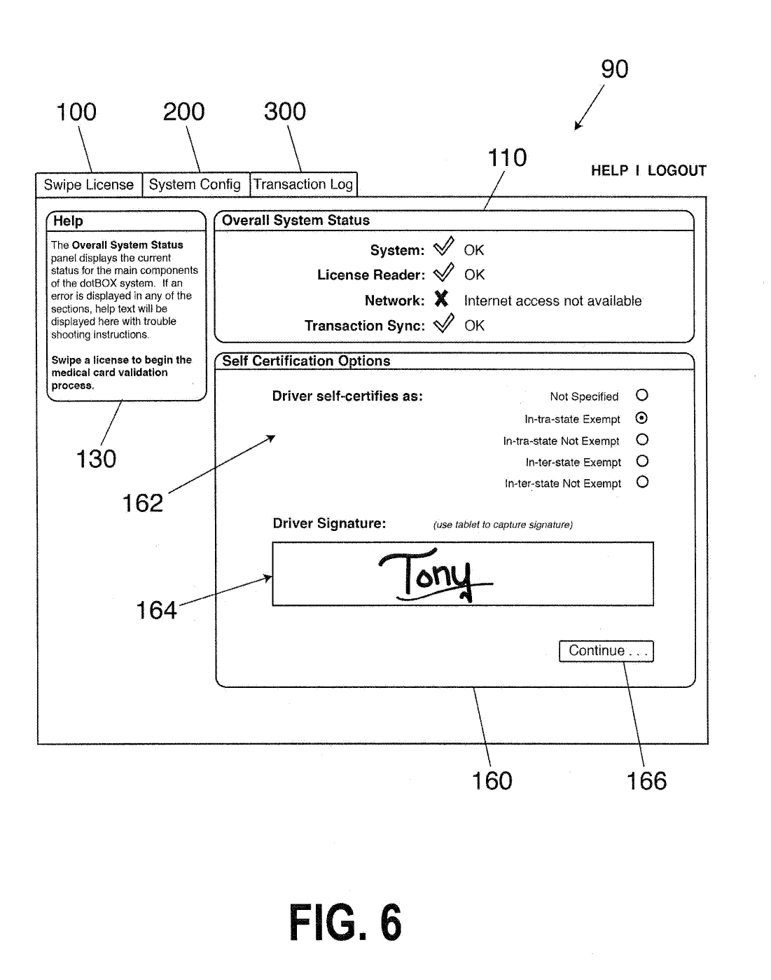

When the user selects the “Continue” button in the input area 150, the network device 20 will generate new web page on the personal computer 12. FIG. 6 schematically illustrates an exemplary screen shot of this new web page 90. With reference to FIG. 6, the new web page 90 may again include the series of tabs 100, 200 and 300 described in conjunction with the initial web page 60 discussed above with respect to FIG. 3. Again, the “Swipe License” tab 100 is selected in the view of FIG. 6. As can be seen from FIG. 6, a “Self Certification Options” panel 160 is now displayed. The panel 160 may include a first input area 162 where the user can select from a number of input options relating to the operator's self-certification. To determine the correct option to be selected in the first input area 162, the user may query the operator and then select the appropriate option. The various choices presented in the first input area 162 may, for example, be presented in a “radio button” format, as illustrated in FIG. 6. In this manner, the user may select from the various choices simply by using a conventional computer pointing device, e.g., a mouse.

With continued reference to FIG. 6, a second input area 164 may include a graphical representation of the operator's signature. To generate this graphical representation, the operator may sign a signature capture pad which may, for example, be attached to the personal computer 12 or to the network device 20 as a USB device via the port 32, FIG. 2. Alternatively, the operator's signature may be captured by an optical reading device which takes a picture of the operator's actual signature on a pre-formatted piece of paper. The barcode scanner, previously described herein, may, for example, function as such an optical reading device.

With further reference to FIG. 6, a third input area 166 may include a “Continue” button. After the user has made the appropriate selection in the input area 162, as described above, the user may click on the Continue button in the input area 164 (again using a mouse or other conventional computer pointing device).

When the user selects the “Continue” button in the input area 164, the network device 20 will generate new web page on the personal computer 12. FIG. 7 schematically illustrates an exemplary screen shot of this new web page 170. With reference to FIG. 7, the new web page 170 may again include the series of tabs 100, 200 and 300 described in conjunction with the initial web page 60 discussed above with respect to FIG. 3. Again, the “Swipe License” tab 100 is selected in the view of FIG. 7. As can be seen from FIG. 7, a “Medical Examiner's Certificate” panel 180 is now displayed. Within the panel 180, an image 182 of a completed medical examiner's certificate is displayed, containing a combination of the operator's driver's license information automatically obtained from the license reader 40 and information manually entered by the operator on the web pages 80 (FIG. 5) and 90 (FIG. 6). The image 182 may, for example, be derived from a portable document format (“PDF”) version of the medical examiner's certificate.

With continued reference to FIG. 7, an input area 184 on the web page 170 may include a “Print Medical Card” button 186 and a “Send to DMV” button 188. The user may, if desired, click on the “Print Medical Card” button 186 (again using a mouse or other conventional computer pointing device) causing the completed medical examiner's certificate to be printed on a printing device attached, for example, to the personal computer 12 or the network device 20. In this manner, a printout of the completed medical examiner's certificate may be given to the operator. The user may also, if desired, save a copy of the PDF image 182 to a local file located at the facility 50, FIG. 1 (e.g., by simply selecting “Save As . . . ” from the File drop down menu of the web browser).

With further reference to FIG. 7, selecting the “Send to DMV” button 188 will cause the medical card information to be sent to the appropriate state's Department of Motor Vehicles, in a manner that will now be described in further detail.

FIG. 8, in general terms, schematically illustrates a portion of a system 500 that may be used to transmit an electronic version of a U.S. Department of Transportation (DOT) medical examiner's certificate from the facility 50 to the appropriate state's Department of Motor Vehicles, e.g., 510, 520.

With continued reference to FIG. 8, the system 500 may include a server 530 connected to the internet 40 via a connection 540, in a conventional manner. The Department of Motor Vehicles offices of various states may also be connected to the internet 40 in a conventional manner (for purposes of illustrative clarity, only two states are illustrated in FIG. 8). More specifically, a first state 510 (labeled “DMV 1”) is shown connected to the internet 40 via a connection 550 and a second state 520 (labeled “DMV 2”) is shown connected to the internet 40 via a connection 560.

When the user selects the “Send to DMV” button 188, FIG. 7, the network device 20 (e.g., FIG. 1) will create an encrypted archive of the medical examiner's certificate completed in the process described previously herein. This encrypted archive may include, for example, a PDF rastered image of the medical examiner's certificate and text files containing plain-text information exactly as it appears on the medical examiner's certificate. After being created, the encrypted archive may be immediately transmitted by the network device 20 to the server 530, via the internet 40 (FIG. 8). Thereafter, the encrypted archive data may be deleted from the network device 20. In this manner, data is stored on the network device 20 for only a short time. In addition, no information is stored on the personal computer 12. This is advantageous in that it helps to facilitate compliance with heath information privacy and security requirements, e.g., those requirements found in The Health Insurance Portability and Accountability Act of 1996 (HIPAA).

Once the encrypted archive has been uploaded to the server 530, the server 530 will transmit it to the appropriate state's Department of Motor Vehicles. This transmission may be performed according to various methodologies, depending upon the type of technology being used by the state in question. In one such methodology, the server 530 may “push” encrypted archive data to the appropriate state as soon as it is received. Using the push methodology, the server 530 will send electronic information to the state every time that a certificate is uploaded to the server 530 from a facility (e.g., the facility 50 described above). The push methodology is advantageous in that it leaves information on the server 530 for the least amount of time. Since the push methodology functions nearly in real time, this also allows the state to send a “ping” back to the facility 50 generating the certificate data acknowledging receipt of the information. This ping can, if desired, actually be used to place an indicator on the medical card before it is printed. Such an indicator may indicate, for example, that the data has successfully been sent to the appropriate state DMV.

Using an alternative methodology, the state may periodically (e.g., once per day) “pull” data from the server 530. Using the pull methodology, the server 530 will store medical certificate data for an appropriate state until the state requests it.

Using a further alternative methodology, the server may deliver medical certificate information to a state via a non-electronic protocol—e.g., by telefacsimile transmission of image data only. This methodology would typically be used only in cases where the state in question lacks the capability to receive the information electronically.

It is noted that the system and methodology describe above embody many advantageous features. For example, because driver's license information is entered automatically using a license reader, the chance for a data entry error by the user is eliminated. Automatically entering information in this manner also ensures that the drivers license information entered will be identical to the information contained in the state's drivers license records, and in the same format. This, in turn, helps to ensure that the medical examiner's certificate will be successfully correlated with the proper drivers license record when the medical examiner's certificate is uploaded to the state. Further, because the manually-entered information is input by selecting from a series of pre-determined options (using, e.g., a radio button format or a drop down list), the risk of user data input error is further minimized.

The foregoing description of specific embodiments has been presented for purposes of illustration and description. The specific embodiments described are not intended to be exhaustive or to suggest a constraint to the precise forms disclosed, and many modifications and variations are possible in light of the above teaching. The illustrated embodiments were chosen and described in order to best explain principles and practical application, to thereby enable others skilled in the art to best utilize the various embodiments with various modifications as are suited to the particular use contemplated. It is intended that the scope of the invention be defined only by the claims appended hereto and their equivalents, except as limited by the prior art.

1. A method for generating a medical examiner's certificate for a commercial driver, said method comprising:
electronically reading license data from said commercial driver's state-issued driver's license;
electronically transmitting said license data to a computer;
viewing a form on a monitor attached to said computer, said form comprising a plurality of data fields;
entering data into said form by
automatically filling at least one of said plurality of data fields with said license data; and
manually filling at least a second of said plurality of data fields using a human interface device attached to said computer.

2. The method of claim 1 and further wherein:
said computer is connected to a local area network;
a network device is connected to said local area network;
said form is generated by said network device and transmitted to said computer by said network device.

3. The method of claim 1 and further wherein:
said form is transmitted by said network device to said computer in a web page format.

4. The method of claim 2 and further comprising:
generating a completed form by completing said entering data; and
storing said completed form on said network device.

5. The method of claim 4 and further comprising:
transmitting data corresponding to said completed form from said network device to a state Department of Motor Vehicles office.

6. The method of claim 5 and further comprising:
deleting said completed form and said data corresponding to said completed form from said network device after said transmitting has been completed.

7. The method of claim 5 and further wherein:
said transmitting data corresponding to said completed form from said network device to a state Department of Motor Vehicles office comprises:
transmitting said data from said network device to a server connected to the internet; and
subsequently transmitting said data from said server to said state Department of Motor Vehicles office.

8. The method of claim 1 and further wherein:
said human interface device comprises a computer mouse.

9. The method of claim 1 and further wherein:
said manually filling at least a second of said plurality of data fields using a human interface device attached to said computer comprises selecting from a plurality of predetermined options on said form.

10. The method of claim 1 and further wherein:
said electronically reading license data from said commercial driver's state-issued driver's license comprises swiping said driver's license through a reading device.

11. The method of claim 4 and further comprising:
printing a copy of said medical examiner's certificate for said commercial driver after said generating a completed form has been accomplished.

12. A system for generating a medical examiner's certificate for a commercial driver, said system comprising:
a computer attached to a local area network;
a network device attached to said local area network;
a reading device attached to said network device, said reading device adapted to electronically read license data from said commercial driver's state-issued driver's license;
a form generated by said network device and displayed on a monitor attached to said computer, said form comprising a plurality of data fields;
wherein, at least one of said plurality of data fields comprises an automatic field that is automatically filled with said license data; and
wherein, at least one of said plurality of data fields comprises a manual field that is manually filled using a human interface device attached to said computer.

13. The system of claim 12 and further wherein:
said form is generated by said network device in a web page format.

14. The system of claim 12 and further wherein:
when said form is completed, storing said completed form on said network device.

15. The system of claim 14 and further wherein:
said network device is adapted to transmit data corresponding to said completed form from said network device to a state Department of Motor Vehicles office and thereafter deleting said completed form and said data corresponding to said completed form from said network device.

16. The system of claim 15 and further comprising:
a server connected to the internet;
wherein, said network device is adapted to transmit said data from said network device to said server; and
wherein, said server is adapted to transmit said data from said server to said state Department of Motor Vehicles office.

17. The system of claim 12 and further wherein:
said human interface device comprises a computer mouse.

18. The system of claim 12 and further wherein:
said reading device comprises a magnetic strip reader.

19. The system of claim 12 and further wherein:
said reading device comprises a barcode scanner.

20. The system of claim 12 and further wherein:
said manual field comprises a plurality of predetermined user-selectable options.
